(19) United States
(12) Patent Application Publication
(10) Pub. No.: US 2008/0140807 A1
(43) Pub. Date: Jun. 12, 2008

(54) SYSTEM AND METHOD FOR AUTOMATICALLY DOWNLOADING NOTICES OF E-FILED PATENT APPLICATIONS

(75) Inventors: CHUNG-I LEE, Tu-Cheng (TW); HAI-HONG LIN, Shenzhen (CN); DE-YI XIE, Shenzhen (CN); CHEN-CHEN ZHANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/831,968

(22) Filed: Aug. 1, 2007

(30) Foreign Application Priority Data
Dec. 8, 2006 (CN) 200610157356.1

(51) Int. Cl. G06F 15/16

(52) U.S. Cl. 709/219; 709/217

(57) ABSTRACT

A system for automatically downloading notices of e-filed patent applications is provided. The system includes a local server. The local application includes: a parameter configuration module for configuring download parameters for downloading notices of e-filed patent applications; a download scheduler module for determining whether it is time to start downloading; a remote connection module for accessing the patent e-filing web site with identification of an applicant when it is time to start downloading, and retrieving information about all the e-filed patent applications of the applicant; and a notice download module for downloading notices to be downloaded and storing the downloaded notices in a database. A related method is also provided.

### BACKGROUND OF THE INVENTION

1. Field of the Invention

The present invention relates to a system and method for automatically downloading notices of electronically-filed (e-filed) patent applications.

2. Description of Related Art

Submitting patent applications to a designated patent office is usually done by post. However, submitting the patent application by post requires a long time. Furthermore, before submitting the patent application, organizing paper works of the patent application also requires a lot of time. Additionally, managing paper documents of a large number of patent applications by the patent office is a burdensome work.

In order to improve efficiency of processing the patent application, cut down manpower cost and financing cost of the patent application process, now many patent offices provide corresponding electronic platforms that allow applicants to submit electronic documents of the patent application to the patent offices. That is to say, the applicants can submit the patent applications electronically (e-filed patent applications). The patent office also releases notices about the e-filed patent application through its electronic platform. The applicant of the e-filed patent application accesses the electronic platform with a user name and a password distributed by the patent office, to check whether there are notices about the e-filed patent application, if there is a notice about the e-filed patent application, the applicant downloads the notice, otherwise, if there are no notices, the applicant would start up the checking-and-downloading procedure repetitiously at later times, so as to track status of the e-filed patent application.

Since different notices of the e-filed patent application are released at different periods, the repetitious checking-and-downloading procedure manually started up by the applicant is another burdensome work, especially when there is a large number of notices of e-filed patent applications need to be checked and downloaded. Moreover, if the applicant does not check and download the notices in time, a time limit designated by the patent office for the applicant to process with the e-filed patent application may be delayed, at a result, the applicant would have to pay an extension fee or even more seriously, the applicant may lose the patent rig ht.

Another problem at present time is that, the notices downloaded manually are uploaded to a case management of the applicant manually one after one, which also brings burdensome work to the applicant.

What is needed, therefore, is a system and method for automatically downloading notices of e-filed patent applications, so as to improve work efficiency and avoid repeating operation.

### SUMMARY OF THE INVENTION

A system for automatically downloading notices of e-filed patent applications according to a preferred embodiment is provided. The system includes a local server that is connected to a remote server through a network. The local application includes: a parameter configuration module for configuring download parameters for downloading notices of e-filed patent applications; a download scheduler module for determining whether it is time to start downloading; a remote connection module for accessing the patent e-filing web site with identification of an applicant when it is time to start downloading, and retrieving information about all the e-filed patent applications of the applicant; and a notice download module for downloading notices from the web site.

Another preferred embodiment provides a method for automatically downloading notices of e-filed patent applications. The method includes: (a) setting download parameters for downloading notices of e-filed patent applications; (b) detecting whether it is time to start downloading; (c) accessing the patent e-filing web site with identification of an applicant, if it is time to start downloading; (d) retrieving information of all e-filed patent applications of the applicant; (e) downloading the notices from the web site; and (f) storing the downloaded notices in a database.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 is a schematic diagram illustrating a system for automatically downloading notices of e-filed patent applications according to a preferred embodiment;

FIG. 2 is a block diagram illustrating function modules of a local application server in FIG. 1; and

FIG. 3 is a flowchart of a preferred method for automatically downloading notices of e-filed patent applications.

### DETAILED DESCRIPTION OF THE PREFERRED EMBODIMENT

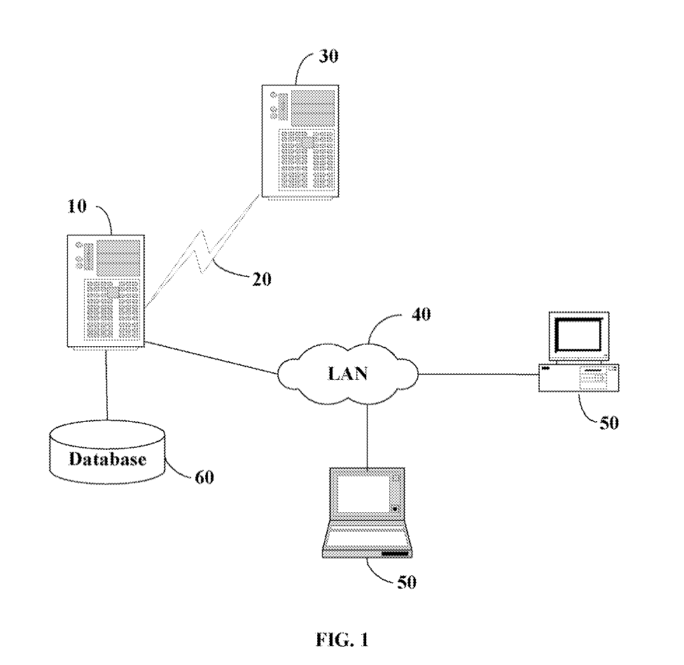

FIG. 1 is a schematic diagram illustrating a system for automatically downloading notices of e-filed patent applications according to a preferred embodiment. The system mainly includes a local server 10, a remote server 30 accessible by the local server 10 via the Internet 20, and a plurality of client computers 50 (only two shown) connected to the local server 10 via a local area network (LAN) 40.

The local server 10 is provided for an applicant to submit patent applications to a patent office via the Internet 20, access the remote server 30 to query information about the e-filed patent applications, and download notices of the e-filed patent applications from the remote server 30. The notices may include: patent application rejection notices, patent application acceptance notices, charge payment notices, Office Actions that state the reasons for refusal and/or any remedies available, and other kinds of notices about the e-filed patent applications.

The local server 10 connects a database 60. The database 60 stores information of all the e-filed patent applications of an applicant who operates the local application server 10. All information of an e-filed patent application is stored in a record in the database 60. If the applicant is a company, information of each e-filed patent application stored in a record may include: information about a proposal department, an inventor (or inventors), an undertaker (or undertakers), and an undertaker department of the e-filed patent application. Such information further includes electronic documents of the e-filed patent application, an application number allocated by a patent office to the e-filed patent application when the patent office accepts the e-filed patent application, notices of the e-filed patent application from the patent office and applicant' response towards the notices.

The remote server 30 receives electronic documents of the e-filed patent application submitted by the applicant from the local server 10, releases notices of the e-filed patent application on the patent e-filing web site. The remote server 30 may be a database server of any patent office, such as the State Intellectual Property Office (SIPO).

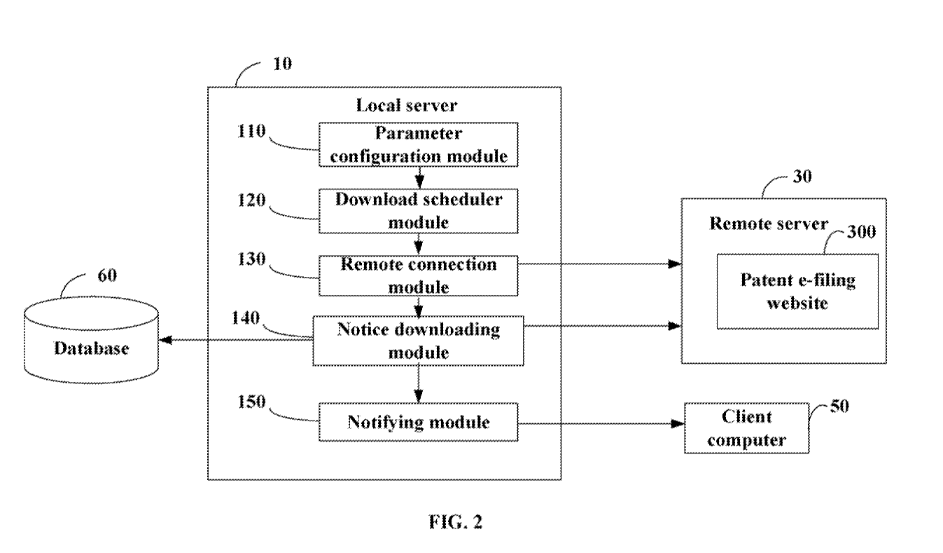

FIG. 2 is a block diagram illustrating function module of the local server 10. The local server 10 typically includes a parameter configuration module 110, a download scheduler module 120, a remote connection module 130, a notice download module 140, and a notifying module 150.

The parameter configuration module 110 is used for configuring download parameters for downloading notices of the e-filed patent applications. The download parameters include an address of a patent e-filing web site 300 located in the remote server 30 where the notices are downloaded, a download time, such as “8:30-16:00 from Monday to Friday”, and notices to be downloaded, such as notices that have not been downloaded.

The download scheduler module 120 is used for detecting whether it is time to start downloading, and further used for detecting whether it is time to stop downloading.

The remote connection module 130 is used for accessing the e-filing patent web site 300 by identification of the applicant when it is time to start downloading, and retrieving information about all the e-filed patent applications of the applicant.

The notice download module 140 is used for downloading notices of the e-filed patent applications from the patent e-filing web site 300, and storing the downloaded notices into the database 60.

The notifying module 160 is used for notifying the applicant to deal with each e-filed patent application based on each corresponding downloaded notice.

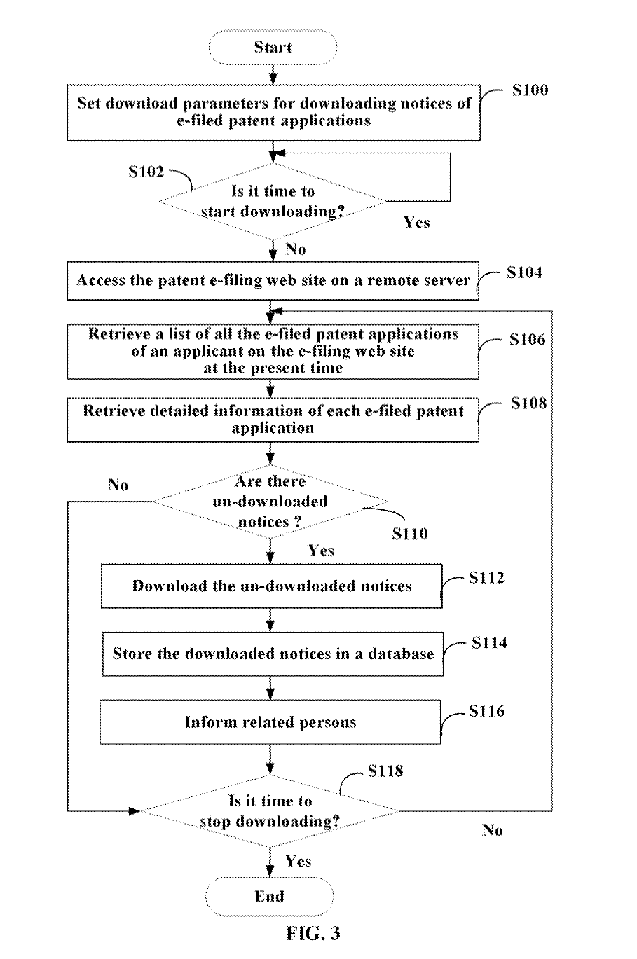

FIG. 3 is a flowchart of a preferred method for automatically downloading notices of e-filed patent applications. In step S100, a user (i.e. a manager) sets download parameters for downloading notices of e-filed patent applications of an applicant via the parameter configuration module 110. The download parameters mainly include an address of a patent e-filing patent web site 300 of a predetermined patent office, a download time, such as “8:30-16:00 from Monday to Friday”, and notices to be downloaded. In this embodiment, the notices to be downloaded are notices that have not been downloaded. The download scheduler module 120 begins timing when the download parameters are set.

In step S102, the download scheduler module 120 detects whether it is time to start downloading. If it is the time to start downloading, in step S104, the remote connection module 130 accesses the patent e-filing web site 300 by identification of the applicant.

In step S106, the remote connection module 130 retrieves a list of all the e-filed patent applications of the applicant from the patent e-filing web site 300. In step S108, the remote connection module 130 retrieves detailed information of each e-filed patent application, such as an application number allocated by the patent office to the e-filed patent application, and notices about the e-filed patent application. The notices may have been downloaded by the applicant or still have not been downloaded.

In step S110, the remote connection module 130 checks whether there are notices of the retrieved e-filed patent applications that have not been downloaded. If there is not any notice that has not been downloaded, the procedure goes to step S 118 directly. Otherwise, if there are notices that have not been downloaded, in step S112, the notice download module 140 downloads the notices from the patent e-filing web site 300. In step S114, the notice download module 140 stores each downloaded notice of an e-filed patent application to a corresponding record of the e-filed application in the database 60.

In step S116, the notifying module 160 notifies related persons (e.g. undertakers of the e-filed patent applications) located at the client computers 50 via the internal network 40, to deal with each e-filed patent application according to each downloaded notice. In step S118, the download scheduler module 120 detects whether it is time to stop downloading, if it is time to stop downloading, the procedure ends, otherwise, the procedure goes to step S106.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for automatically downloading notices of e-filed patent applications from an e-filing web site which is installed on a remote server, the system comprising a local server which is selectively connected to the remote server via a network, the local server comprising:
a parameter configuration module for configuring download parameters for downloading notices of e-filed patent applications;
a download scheduler module for determining whether it is time to start downloading;
a remote connection module for accessing the e-filing web site with identification of an applicant when it is time to start downloading, and retrieving information about all the e-filed patent applications of the applicant; and
a notice download module for downloading notices from the web site.

2. The system as claimed in claim 1, wherein the local application server further comprises a notifying module for notifying the applicant to deal with an e-filed patent application based on a corresponding downloaded notice.

3. The system as claimed in claim 1, wherein the download scheduler module is further used for determining whether it is time to stop downloading.

4. A computer-based method for automatically downloading notices of e-filed patent applications, the method comprising:
setting download parameters for downloading notices of e-filed patent applications;
detecting whether it is time to start downloading;
accessing the e-filing web site with identification of an applicant, if it is time to start downloading;
retrieving information of all e-filed patent applications of the applicant;
downloading the notices to be downloaded from the web site; and
storing the downloaded notices.

5. The method as claimed in claim 4, further comprising:
notifying the applicant to deal with each e-filed patent application based on each corresponding downloaded notice.

6. The method as claimed in claim 4, further comprising:
detecting whether it is time to stop downloading.
